(19) United States
(12) Patent Application Publication
(10) Pub. No.: US 2026/0251500 A1
(43) Pub. Date: Aug. 27, 2026

(54) SPECTRAL RADIANCE SOURCE AND SPECTRAL RADIANCE CALIBRATION METHOD

(71) Applicant: National Institute of Metrology, China, Beijing (CN)

(72) Inventors: Zhifeng Wu, Beijing (CN); Caihong Dai, Beijing (CN); Ling Li, Beijing (CN); Ruoduan Sun, Beijing (CN); Yanfei Wang, Beijing (CN)

(21) Appl. No.: 19/539,183

(22) Filed: Feb. 13, 2026

(30) Foreign Application Priority Data
Feb. 26, 2025 (CN) 2025102148035

(51) Int. Cl. G01J 3/10; G01J 3/02; G01J 3/28; G01N 21/27

(52) U.S. Cl. CPC G01J 3/10; G01J 3/0251; G01J 3/0291; G01J 3/28; G01N 21/274

(57) ABSTRACT

A spectral radiance source includes: a first integrating sphere, a second integrating sphere, an optical fiber, a hollow connecting column, a baffle, and a light source. The second integrating sphere is arranged inside the first integrating sphere and connected to the first integrating sphere via the hollow connecting column. The optical fiber is arranged within the hollow connecting column, and extends between the light source and a light entry port on the second integrating sphere. The baffle is inside the second integrating sphere and arranged between the light entry port and a second light exit port. The spectral radiance source may be used to calibrate an optical instrument.

### PRIORITY CLAIM

This application claims the benefit of the filing date of the People’s Republic of China Patent Application Serial No. 2025102148035, filed February 26, 2025, for “SPECTRAL RADIANCE SOURCE AND SPECTRAL RADIANCE CALIBRATION METHOD, the disclosure of which is hereby incorporated herein in its entirety by this reference.”

### TECHNICAL FIELD

The present disclosure relates to the field of optical technology, particularly to a spectral radiance source and a spectral radiance calibration method.

### BACKGROUND

A spectral radiance source is an object or device capable of emitting light radiation within a specific wavelength range. A radiance source is often used as a standard or reference light source for calibrating an optical instrument and measuring. The uniformity of light emitted from a spectral radiance source is of great significance for the accuracy and reliability of optical instrument calibration and measurement.

An integrating sphere light source made using the diffuse reflection characteristics of the integrating sphere is a commonly used spectral radiance source. However, the uniformity of the light emitted from a traditional integrating sphere light source is difficult to meet the requirements for high-precision optical radiation calibration.

Therefore, how to improve the uniformity of the light emitted from a spectral radiance source is an urgent technical problem that needs to be solved in this field.

### BRIEF SUMMARY

The present disclosure provides a spectral radiance source and a spectral radiance calibration method, which are used to solve the defect that the uniformity of the light emitted from the traditional integrating sphere light source in the prior art is difficult to meet the requirements for high-precision optical radiation calibration, and to improve the uniformity of the light emitted from the spectral radiance source.

The present disclosure provides a spectral radiance source comprising: a first integrating sphere, a second integrating sphere, an optical fiber, a hollow connecting column, a baffle, and a light source;

wherein the diameter of the first integrating sphere is larger than that of the second integrating sphere; and the second integrating sphere is arranged inside the first integrating sphere and is connected to the first integrating sphere via the hollow connecting column;

wherein a first light exit port is arranged on the first integrating sphere; a light entry port and a second light exit port are arranged on the second integrating sphere; and the light entry port and the hollow connecting column are coaxially arranged;

wherein the optical fiber is arranged within the hollow connecting column, with one end of the optical fiber connected to the light source and the other end of the optical fiber arranged at the light entry port, and the optical fiber is used to guide the light emitted from the light source into the light entry port;

wherein the baffle is inside the second integrating sphere and arranged between the light entry port and the second light exit port, serving to block light entering the second integrating sphere through the light entry port from directly emerging from the second light exit port; and

wherein the inner wall of the first integrating sphere, the inner and outer walls of the second integrating sphere, the baffle, and the inner and outer walls of the hollow connecting column are all coated with a diffuse reflective material layer.

According to the spectral radiance source provided by the present disclosure, the center of the first integrating sphere coincides with the center of the second integrating sphere.

According to the spectral radiance source provided by the present disclosure, it further comprises: a third integrating sphere; the third integrating sphere is set inside the first integrating sphere and outside the second integrating sphere; and the center of the third integrating sphere coincides with the center of the first integrating sphere;

the third integrating sphere is equipped with a third light exit port, and the third light exit port is not coaxial with either the first light exit port or second light exit port; and

the inner and outer walls of the third integrating sphere are coated with the diffuse reflective material layer.

According to the spectral radiance source provided by the present disclosure, the light entry port and the second light exit port are coaxially arranged; and the baffle is arranged parallel to the light entry port.

According to the spectral radiance source provided by the present disclosure, the minor arc between a third center point and a fourth center point on the third integrating sphere is determined based on the diameter of the third integrating sphere, wherein the third center point is the center point of the third light exit port, and wherein the fourth center point is the center point of the cross-section between the hollow connecting column and the third integrating sphere.

According to the spectral radiance source provided by the present disclosure, the number of the third integrating sphere(s) is one or more, wherein when the number of the third integrating spheres is more than one, the third light exit ports on respective third integrating spheres are not coaxial with each other.

According to the spectral radiance source provided by the present disclosure, the central angle corresponding to the minor arc between a first center point and a second center point on the second integrating sphere is determined based on the diameter of the second integrating sphere, the first center point is the center point of the second light exit port, and the second center point is the center point of the light entry port.

According to the spectral radiance source provided by the present disclosure, the baffle is arranged perpendicular to the tangent of the minor arc.

According to the spectral radiance source provided by the present disclosure, the first light exit port and the hollow connecting column are coaxially arranged.

The present disclosure also provides a spectral radiance calibration method implemented based on any of the spectral radiance source as described above, and the method comprises:

controlling an optical instrument to be calibrated to collect the spectral radiance of the light emerging from the first light exit port of the spectral radiance source; and

obtaining the calibration results of the optical instrument to be calibrated based on the spectral radiance value collected by the optical instrument to be calibrated and the known spectral radiance value of the spectral radiance source.

The present disclosure provides a spectral radiance source and a spectral radiance calibration method. The spectral radiance source comprises a first integrating sphere, a second integrating sphere, an optical fiber, a hollow connecting column, a baffle, and a light source. Before exiting through the first light exit port arranged on the first integrating sphere, the light emitted from the light source is reflected multiple times inside the second integrating sphere, and then is reflected multiple times inside the first integrating sphere. The spectral radiance source and spectral radiance calibration method provided by the present disclosure can enhance the spatial uniformity and angular uniformity of the light emitted from the spectral radiance source through multiple reflections of the light without the need to arrange a diaphragm at the light exit port and/or without increasing the volume of the integrating spheres, have a minimal impact on the spectral radiance of the light emitted from the spectral radiance source, and improve the Lambertian characteristics of the light emitted from the spectral radiance source, better meets the uncertainty requirements for spectral radiance calibration. The spectral radiance source has a simple structure, low manufacturing cost, simple manufacturing process, and broad application prospects.

### BRIEF DESCRIPTION OF THE DRAWINGS

In order to more clearly illustrate the technical solutions of the present disclosure or the prior art, a brief introduction will be given below to the accompanying drawings required for describing the Examples or the prior art. It is obvious that the accompanying drawings described below are some Examples of the present disclosure. For those skilled in the art, other drawings can be obtained based on these drawings without creative labor.

FIG. 1 is a schematic diagram of the structure of an integrating sphere light source using a built-in light source in the related art.

FIG. 2 is a schematic diagram of the structure of an integrating sphere light source using an external light source in the related art.

FIG. 3 is a schematic diagram of the structure of a cascaded integrating sphere light source using a built-in light source in the related art.

FIG. 4 is a schematic diagram of the structure of a cascaded integrating sphere light source using an external light source in the related art.

FIG. 5 is a first schematic diagram of the structure of the spectral radiance source provided by the present disclosure.

FIG. 6 is a second schematic diagram of the structure of the spectral radiance source provided by the present disclosure.

FIG. 7 is a flowchart illustrating the spectral radiance calibration method provided by the present disclosure.

### Reference numerals

501: spectral radiance source; 502: first integrating sphere; 503: second integrating sphere; 504: optical fiber; 505: hollow connecting column; 506: baffle; 507: light source; 508: first light exit port; 509: light entry port; 510: second light exit port; 511: diffuse reflective material layer; 512: supporting structure; 601: third integrating sphere; 602: third light exit port.

### DETAILED DESCRIPTION

In order to clarify the purpose, technical solution, and advantages of the present disclosure, the technical solution of the present disclosure will be described clearly and completely in conjunction with the accompanying drawings. Obviously, the described examples are a part of the examples of the present disclosure, not all of them. Based on the examples of the present disclosure, all other examples obtained by those skilled in the art without creative labor are within the scope of protection of the present disclosure.

In the description of the present disclosure, it should be noted that unless otherwise specified and limited, the terms “installation.” “connection.” and “connected” should be broadly understood. For example, it can be a fixed connection, a detachable connection, or an integral connection. It can be a mechanical connection or an electrical connection. It can be direct connection, indirect connection through an intermediate medium, or internal communication between two components. For those skilled in the art, the specific meanings of the above terms in the present disclosure can be understood according to the specific situation.

In the description herein, the terms “first.” “second.” etc., are used to distinguish similar objects and not to describe a specific order or sequence. It should be understood that the data used in this way can be interchanged in appropriate circumstances, so that the examples of the present disclosure can be implemented in an order other than those illustrated or described herein, and the objects distinguished by “first.” “second.” etc., are usually of one class, without limiting the number of objects. For example, the first object can be one or more. In addition, in the description herein, “and/or” represents at least one of the connected objects, and the character “/” generally indicates an “or” relationship between preceding and following related objects.

It should be noted that an integrating sphere light source, which utilizes the diffuse reflection characteristics of the integrating sphere, is a commonly used spectral radiance source. An integrating sphere light source is usually composed of an integrating sphere and a built-in or external light source. The inner wall of an ideal integrating sphere is coated with a uniform high reflectivity coating, and the inner wall of the integrating sphere is uniform everywhere. A baffle is arranged between the light source and the light exit port of the integrating sphere, so that the light emitted from the light source cannot directly emerge from the light exit port of the integrating sphere.

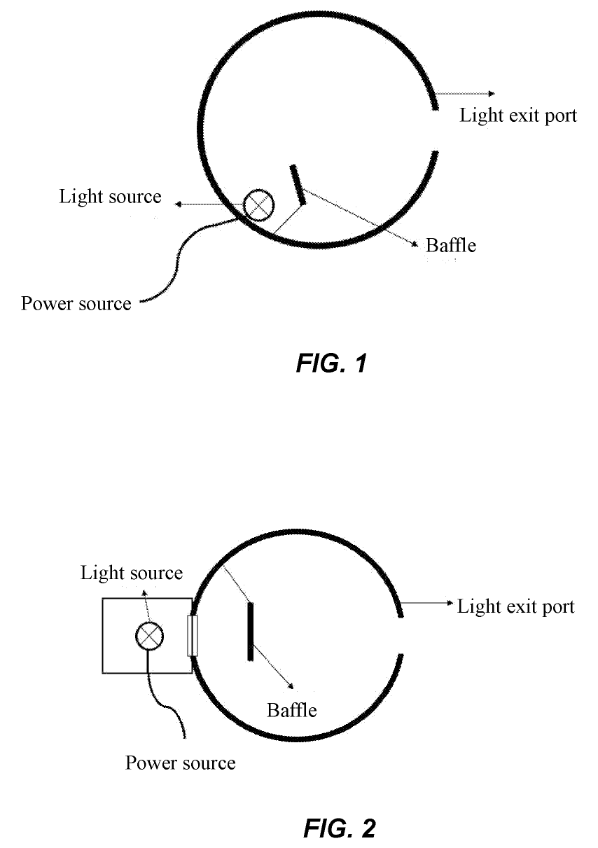

FIG. 1 is a schematic diagram of the structure of an integrating sphere light source using a built-in light source in the related art. FIG. 2 is a schematic diagram of the structure of an integrating sphere light source using an external light source in the related art. The structure of a traditional integrating sphere light source with a built-in light source is shown in FIG. 1. The structure of a traditional integrating sphere light source with an external light source is shown in FIG. 2.

It should be noted that both the baffles in FIGS. 1 and FIG. 2 use the same spray coated material as the inner wall of the integrating sphere. The baffle can be rectangular or circular, and is typically thin. Due to the obstruction of the baffle, the light emitted from the light source cannot directly emerge from the light exit port. Therefore, the light will undergo multiple reflections inside the integrating sphere, making the radiation of the inner wall become uniform and ensuring the uniformity of the light emerging from the light exit port.

FIG. 2 shows a traditional integrating sphere light source, the light emitted from the external light source enters the integrating sphere through direct incidence rather than diffusion. In the traditional integrating sphere light source shown in FIG. 1, as the built-in light source itself is not a diffuse reflective material, the diffuse reflection characteristics inside the integrating sphere willed be damaged. Therefore, in the related art, the uniformity of the light emerging from the light exit port of the integrating sphere light source can be further improved through a cascade structure.

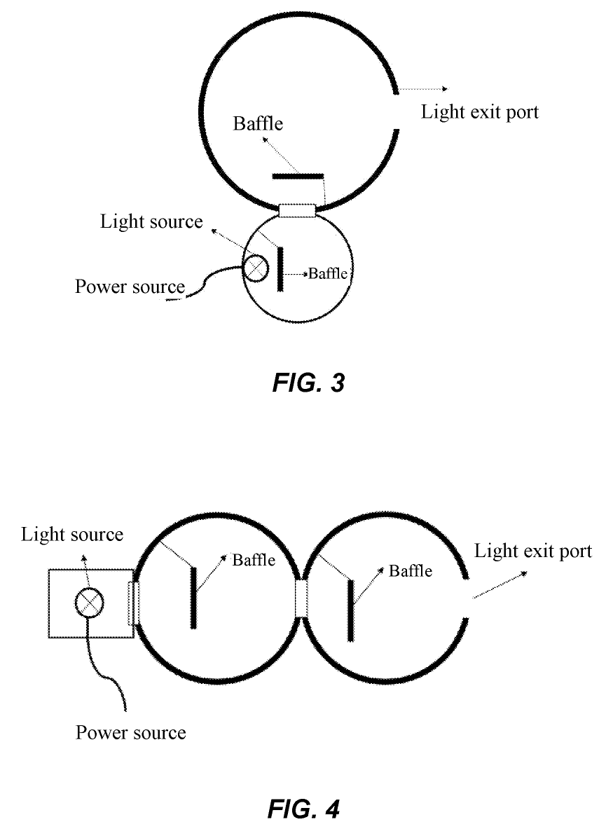

FIG. 3 is a schematic diagram of the structure of a cascaded integrating sphere light source using a built-in light source in the related art. FIG. 4 is a schematic diagram of the structure of a cascaded integrating sphere light source using an external light source in the related art. The structure of a traditional cascaded integrating sphere light source with a built-in light source is shown in FIG. 3. The structure of a traditional cascaded integrating sphere light source with an external light source is shown in FIG. 4.

In the traditional cascaded integrating sphere light sources shown in FIGS. 3 and 4, two integrating spheres are both used in series. The light emerging from the light exit port of the first integrating sphere has good Lambertian characteristics, then enters the second integrating sphere, and finally emerges from the light exit port of the second integrating sphere.

However, on the one hand, the radiation characteristics of the emergent light of a traditional cascaded integrating sphere light source are still limited by the structure of the second integrating sphere. Although the baffle and the connecting column between the baffle and the inner wall are coated with the same high reflectivity coating as the inner wall, there is still a certain impact on the diffuse reflection inside the integrating sphere. The connecting column is usually very thin and has a small surface area, while the surface area of the baffle cannot be ignored, which, to some extent, damages the spherical symmetry structure of the integrating sphere and ultimately affects the uniformity and Lambertian characteristics of the emergent light of the traditional cascaded integrating sphere light source. Meanwhile, the processing cost of the integrating sphere light source is related to the size of the integrating sphere, and the cascaded integrating sphere with two connected spheres has a higher cost.

On the other hand, the ratio of the radiation of light emerging from the first integrating sphere and entering into the second integrating sphere to the radiation of light entering the first integrating sphere is directly proportional to the ratio of the surface area at the connection between the two integrating spheres to the inner surface area of the first integrating sphere. Therefore, compared to the traditional integrating sphere light sources shown in FIGS. 1 and FIG. 2, the spectral radiance of the emergent light of the traditional cascaded integrating sphere light sources shown in FIGS. 3 and FIG. 4 will be greatly reduced.

In recent years, the requirements for the accuracy of calibration and measurement of optical instruments in the field of optical remote sensing have become increasingly high, especially in global climate change research. In Earth’s radiation balance research, it is necessary to accurately measure the total solar radiation received by the Earth and the radiation emitted by the Earth into space, so as to accurately predict the trend of Earth’s climate change. Currently, the international demand for lower measurement uncertainty of solar irradiance and Earth’s reflected radiance is rising, with required uncertainty levels of up to 0.01% and 0.1%, respectively.

The uncertainty of radiance calibration for an optical instrument is determined by the stability and Lambertian characteristics of the integrating sphere light source, and the properties of the optical instrument to be calibrated. In current reports, the non-uniformity of the light emitted from a traditional integrating sphere light source has not been observed to be less than 0.1%. Meanwhile, the angular non-uniformity of the light emitted from a traditional integrating sphere light source also affects the radiance calibration of an optical instrument.

The traditional cascaded integrating sphere light sources shown in FIGS. 3 and 4 are large in volume, and the non-uniformity of the light emitted from the traditional cascaded integrating sphere light source still cannot be less than 0.1%.

In order to improve the uniformity of the light emitted from a traditional integrating sphere light source, in principle, one can only arrange a diaphragm at the light exit port of the traditional integrating sphere light source, selecting only the specific area of optical radiation at the center of the light exit port. When the integrating sphere and the light exit port are large enough, and the selected measurement area is small enough, the non-uniformity of light emitted by the traditional integrating sphere light source can achieve below 0.1%.

However, the larger the integrating sphere, the smaller the radiance value of the light emitted from the integrating sphere light source, the greater the processing cost and the waste of light source power of the light source. When the spectral radiance of the light emitted from the integrating sphere light source is too weak, the light emitted from the integrating sphere light source cannot meet the requirements for radiance calibration of an optical instrument. The testing for angular uniformity of the light emitted from the integrating sphere light source also has similar problems.

Therefore, the inherent characteristics of a traditional integrating sphere light source alone cannot guarantee that the non-uniformity of the light emitted from the traditional integrating sphere light source is less than 0.1%. Thus, how to improve the uniformity of the light emitted from a spectral radiance source is a technical problem urgently needing a solution in this field.

In this regard, the present disclosure provides a spectral radiance source capable of achieving high uniformity. The spectral radiance source provided by the present disclosure comprises a first integrating sphere, a second integrating sphere, a hollow connecting column, an optical fiber, and a light source. The first integrating sphere and the second integrating sphere are connected via the hollow connecting column, and the hollow connecting column has good rigidity and serves to support the first integrating sphere and the second integrating sphere. The optical fiber passes through the hollow connecting column, with one end connected to the light source and the other end arranged at the light entry port on the second integrating sphere. The light radiation emitted from the light source is transmitted through the optical fiber and then enters the first integrating sphere from a second light exit port on the second integrating sphere, and ultimately the light radiation is output through the first integrating sphere.

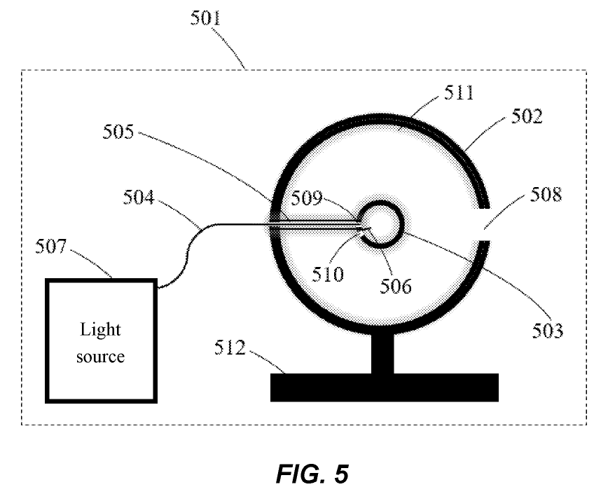

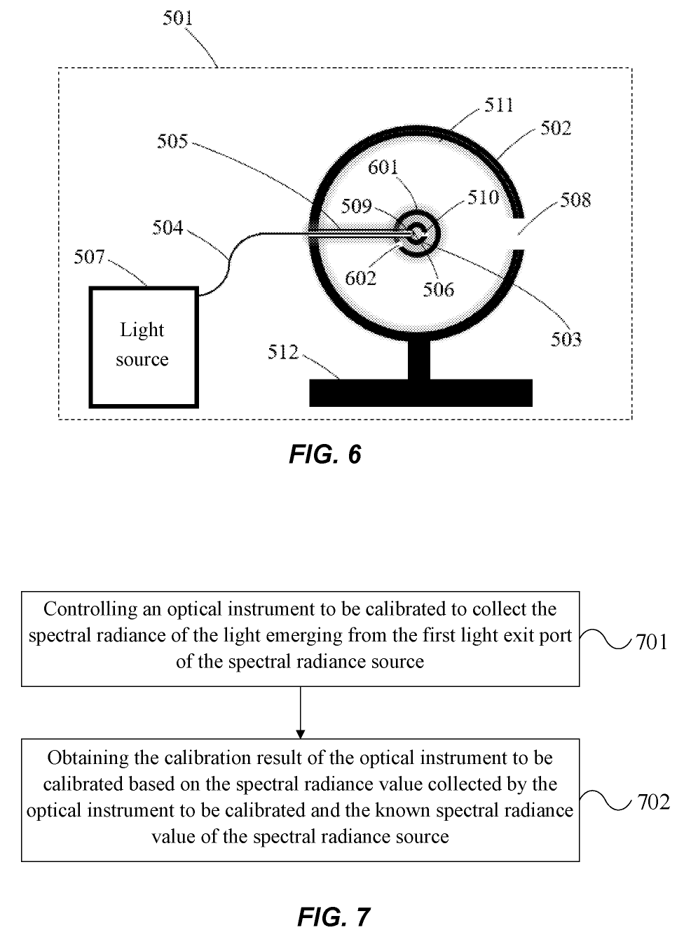

The spectral radiance source provided by the present disclosure is described below in conjunction with FIGS. 5 and 6.

FIG. 5 is one of the structural schematic diagrams of the spectral radiance source provided by the present disclosure. As shown in FIG. 5, the spectral radiance source 501 provided by the present disclosure comprises: a first integrating sphere 502, a second integrating sphere 503, an optical fiber 504, a hollow connecting 505, a baffle 506, and a light source 507.

The diameter of the first integrating sphere 502 is larger than that of the second integrating sphere 503. The second integrating sphere 503 is arranged inside the first integrating sphere 502 and connected to the first integrating sphere 502 via the hollow connecting column 505.

The first integrating sphere 502 is provided with a first light exit port 508. The second integrating sphere 503 is provided with a light entry port 509 and a second light exit port 510. The light entry port 509 and the hollow connecting column 505 are coaxially arranged.

The optical fiber 504 is arranged within the hollow connecting column 505, with one end of the optical fiber 504 connected to the light source 507 and the other end of the optical fiber 504 arranged at the light entry port 509. The optical fiber 504 is used to guide the light emitted from the light source 507 into the light entry port 509.

The baffle 506 is inside the second integrating sphere 503 and arranged between the light entry port 509 and the second light exit port 510, serving to block the light entering the second integrating sphere 503 through the light entry port 509 from directly emerging from the second light exit port 510.

The inner wall of the first integrating sphere 502, the inner and outer walls of the second integrating sphere 503, the baffle 506, and the inner and outer walls of the hollow connecting column 505 are all coated with a diffuse reflective material layer 511.

Specifically, the light emitted from the light source 507 can enter into the second integrating sphere 503 through the optical fiber 504 arranged inside the hollow connecting column 505 and the light entry port 509 arranged on the second integrating sphere 03.

The baffle 506 arranged between the light entry port 509 and the second light exit port 510 can block the light entering the second integrating sphere 503 through the light entry port 509 from directly emerging from the second light exit port 510, so as to allow the light entering the second integrating sphere 503 to undergo multiple reflections within the second integrating sphere 503, and then enter the first integrating sphere 502 through the second light exit port 510 arranged on the second integrating sphere 503.

The light entering the first integrating sphere 502 through the second light exit port 510 undergoes multiple reflections within the first integrating sphere 502 and can then emerge from the first light exit port 508 arranged on the first integrating sphere 502.

Optionally, if the radius of the first integrating sphere 502 is R and the radius of the second integrating sphere 503 is r, then the central angle θ < 2 arcsin (r/R). Usually, the ratio of the second integrating sphere to the first integrating sphere is set to be less than 1:3, that is, θ < 39°.

Optionally, the light source 507 in the examples of the present disclosure may comprise a laser, a plasma light source, an LED lamp, and a bromine tungsten lamp, etc.

It should be noted that the spectral radiance of the light emitted from the light source 507 in the examples of the present disclosure can be determined based on actual needs. The spectral radiance of the light emitted from the light source 507 is not specifically limited in the examples of the present disclosure.

Optionally, the baffle 506 in the examples of the present disclosure can be circular or square. The size of the baffle 506 can be twice the diameter of the hollow connecting column, and the distance from the baffle to the light entry port is equal to the radius of the hollow connecting column. The size of the hollow connecting column can be twice the diameter of the optical fiber (the outer cladding of an optical fiber typically has a diameter of 125 μm, its doubled value gives a diameter of 250 μm).

For a first integrating sphere with a diameter of 10 cm, when the diameter of the second integrating sphere is one-third of the diameter of the first integrating sphere, the cross-sectional area of the hollow connecting column is π × 0.025 cm × 5 cm × 2/3=0.26 cm2. For a traditional integrating sphere light source, not counting the connecting component of the baffle, the diameter of the baffle is typically 2 cm, and the baffle area is π × 1 cm × 1 cm = 3.14159 cm2. The spectral radiance source provided by the present disclosure has a significantly smaller impact on the uniformity of the sphere.

It should be noted that the diffuse reflective material in the examples of the present disclosure refers to a material that can cause irregular reflection of light on its surface. The characteristic of the diffuse reflective material is that the reflected light is evenly distributed in all directions, without forming obvious specular reflections or light spots. In the examples of the present disclosure, a diffuse reflective coating can be used to form the diffuse reflective material layer 511 on the inner wall of the first integrating sphere 502, the inner and outer walls of the second integrating sphere 503, the baffle 506, and the inner and outer walls of the hollow connecting column 505.

It should be noted that the reflectivity of the diffuse reflective material layer 511 in the examples of the present disclosure can be determined based on actual needs, and the reflectivity of the diffuse reflective material layer 511 is not limited in the examples of the present disclosure.

The spectral radiance source in the examples of the present disclosure comprises a first integrating sphere, a second integrating sphere, an optical fiber, a hollow connecting column, a baffle, and a light source. Before emerges from the first light exit port arranged on the first integrating sphere, the light emitted from the light source is reflected multiple times inside the second integrating sphere, and then reflected multiple times inside the first integrating sphere. The spectral radiance source can enhance the spatial uniformity and angular uniformity of the light emitted from the spectral radiance source through multiple reflections of light without the need to arrange a diaphragm at the light exit port and/or increasing the volume of the integrating sphere, have minimal impact on the spectral radiance of the light emitted from the spectral radiance source, and improve the Lambertian characteristics of the light emitted from the spectral radiance source, and better meets the uncertainty requirements for spectral radiance calibration. The spectral radiance source has a simple structure, low manufacturing cost, simple manufacturing process, and broad application prospects.

As an optional example, the center of the first integrating sphere 502 coincides with the center of the second integrating sphere 503.

In the example of the spectral radiance source of the present disclosure, the center of the first integrating sphere coinciding with the center of the second integrating sphere can better preserve the spherical symmetry of the diffuse reflection inside the integrating spheres and can further improve the uniformity of the light emitted from the spectral radiance source.

As an optional example, the central angle corresponding to the minor arc between the first center point and the second center point on the second integrating sphere 503 is determined based on the diameter of the second integrating sphere. The first center point is the center point of the second light exit port 510, and the second center point is the center point of the light entry port 509.

As an optional example, the baffle 506 is arranged perpendicular to the tangent of the minor arc.

It should be noted that the spectral radiance source in the example of the present disclosure further comprises a support structure 512. The support structure 512 is connected to the first integrating sphere 502 for supporting the first integrating sphere 502.

In the example of the spectral radiance source of the present disclosure, the central angle corresponding to the minor arc between the center point of the first light exit port and the center point of the light entry port is determined based on the diameter of the first integrating sphere, so that the second integrating sphere has a certain internal space, and can also serve as a baffle, which can make the light more fully reflected in the second integrating sphere and the first integrating sphere, and further improve the uniformity of the light emitted from the spectral radiance source. The baffle is arranged perpendicular to the tangent of the minor arc, which can better block the light entering the second integrating sphere through the light entry port from directly emerging from the second light exit port, thereby better ensuring that the spectral radiance of the light emitted from the spectral radiance source does not decrease.

FIG. 6 is a second schematic diagram of the structure of the spectral radiance source provided by the present disclosure. As shown in FIG. 6, the spectral radiance source 501 provided by the present disclosure further comprises a third integrating sphere 601. The third integrating sphere 601 is arranged inside the first integrating sphere 502 and outside the second integrating sphere 503. The center of the third integrating sphere 601 coincides with the center of the first integrating sphere 502.

The third integrating sphere 601 is provided with a third light exit port 602, which is not coaxial with either the first light exit port 508 or the second light exit port 510.

The inner and outer walls of the third integrating sphere 601 are coated with a diffuse reflective material layer 511.

Specifically, in order to further improve the uniformity of the light emitted from the spectral radiance source 501 provided by the present disclosure, a third integrating sphere 601 is added between the first integrating sphere 502 and the second integrating sphere 503 in the example of the present disclosure.

As shown in FIG. 6, the light emitted from the light source 507 can enter into the second integrating sphere 503 through the optical fiber 504 arranged inside the hollow connecting column 505 and the light entry port 509 arranged on the second integrating sphere 503.

The baffle 506 arranged between the light entry port 509 and the second light exit port 510 can block the light entering the second integrating sphere 503 through the light entry port 509 from directly emerging from the second light exit port 510, so that the light entering the second integrating sphere 503 can undergo multiple reflections inside the second integrating sphere 503 and then enter the third integrating sphere 601 through the second light exit port 510 arranged on the second integrating sphere 503.

The light entering the third integrating sphere 601 through the second light exit port 510 undergoes multiple reflections inside the third integrating sphere 601, and can then enter the first integrating sphere 502 through the third light exit port 602 arranged on the third integrating sphere 601.

The light entering the first integrating sphere 502 through the third light exit port 602 undergoes multiple reflections within the first integrating sphere 502 and can then emerge from the first light exit port 508 arranged on the first integrating sphere 502.

Optionally, the radius range of the third integrating sphere 601 is less than or equal to one-third of the radius of the first integrating sphere. The radius of the second integrating sphere is one-third of the radius of the third integrating sphere.

It should be noted that the grey areas in FIGS. 5 and 6 represent the diffuse reflective material layer 511.

As an optional example, the number of the third integrating sphere(s) 601 is one or more. When the number of the third integrating spheres 601 is more than one, the third light exit port s 602 on respective third integrating spheres 601 are not coaxial with each other.

The spectral radiance source in the example of the present disclosure further comprises a third integrating sphere. The light emitted from the light source is reflected multiple times inside the second integrating sphere, the third integrating sphere, and the first integrating sphere in sequence, and then emerges from the first light exit port arranged on the first integrating sphere. By increasing the reflection of light inside the integrating sphere, the uniformity of the light emitted from the spectral radiance source can be further improved, and the Lambertian characteristics of the light emitted from the spectral radiance source can be further improved.

As an optional example, the light entry port 509 is coaxially arranged with the second light exit port 510. The baffle 506 is arranged parallel to the light entry port 509.

In the example of the spectral radiance source of the present disclosure, the center of the first integrating sphere coinciding with the center of the second and third integrating spheres can better preserve the spherical symmetry of diffuse reflection inside the integrating sphere and further improve the uniformity of the light emitted from the spectral radiance source. The baffle is arranged parallel to the light entry port, which can better block the light entering the second integrating sphere through the light entry port from directly emerging from the second light exit port, thereby better ensuring that the spectral radiance of the light emitted from the spectral radiance source does not decrease.

As an optional example, the central angle corresponding to the minor arc between the third center point and the fourth center point on the third integrating sphere 601 is determined based on the diameter of the third integrating sphere 601. The third center point is the center point of the third light exit port 602, and the fourth center point is the center point of the cross-section between the hollow connecting column 505 and the third integrating sphere 601.

As an optional example, the first light exit port 508 and the hollow connecting column 505 are coaxially arranged.

In the example of the spectral radiance source of the present disclosure, the central angle corresponding to the minor arc between the center point of the third light exit port and the center point of the cross-section of the hollow connecting column and the third integrating sphere is less than 39° and the first light exit port and the hollow connecting column are coaxially arranged, so that the second integrating sphere has a certain internal space, and can also serve as a baffle, which can make the light more fully reflected in the second integrating sphere and the first integrating sphere, and further improve the uniformity of the light emitted from the spectral radiance source.

FIG. 7 is a flowchart of the spectral radiance calibration method provided by the present disclosure. The spectral radiance calibration method provided by the present disclosure is implemented based on the aforementioned spectral radiance source 501. As shown in FIG. 7, the method comprises: step 701: controlling an optical instrument to be calibrated to collect the spectral radiance of the light emerging from the first light exit port 508 of the spectral radiance source 501; and

step 702: obtaining the calibration result of the optical instrument to be calibrated based on the spectral radiance value collected by the optical instrument to be calibrated and the known spectral radiance value of the spectral radiance source 501.

The examples of the present disclosure enable more accurate and reliable spectral radiance calibration based on the spectral radiance source provided by the present disclosure by controlling the optical instrument to be calibrated to collect the spectral radiance of the light emerging from the first light exit port of the spectral radiance source and further obtaining the calibration result of the optical instrument to be calibrated based on the spectral radiance value collected by the optical instrument to be calibrated and the known spectral radiance value of the spectral radiance source.

Finally, it should be noted that the above examples are only used to illustrate the technical solution of the present disclosure, and not to limit it. Although the present disclosure has been described in detail with reference to the aforementioned examples, those skilled in the art should understand that they can still modify the technical solutions recited in the aforementioned examples, or equivalently replace some of the technical features therein. However, these modifications or replacements do not cause the essence of corresponding technical solutions to deviate from the spirit and scope of the technical solutions of the examples of the present disclosure.

What is claimed is:

1. A spectral radiance source, comprising: a first integrating sphere, a second integrating sphere, an optical fiber, a hollow connecting column, a baffle, and a light source;
wherein the diameter of the first integrating sphere is larger than that of the second integrating sphere, and the second integrating sphere is arranged inside the first integrating sphere and connected to the first integrating sphere via the hollow connecting column;
wherein a first light exit port is arranged on the first integrating sphere, a light entry port and a second light exit port are arranged on the second integrating sphere, and the light entry port and the hollow connecting column are coaxially arranged;
wherein the optical fiber is arranged within the hollow connecting column, with one end of the optical fiber connected to the light source and the other end of the optical fiber arranged at the light entry port, and the optical fiber is used to guide the light emitted from the light source into the light entry port;
wherein the baffle is inside the second integrating sphere and arranged between the light entry port and the second light exit port, serving to block the light entering the second integrating sphere through the light entry port from directly emerging from the second light exit port; and
wherein the inner wall of the first integrating sphere, the inner and outer walls of the second integrating sphere, the baffle, and the inner and outer walls of the hollow connecting column are all coated with a diffuse reflective material layer.

2. The spectral radiance source of claim 1, wherein the center of the first integrating sphere coincides with the center of the second integrating sphere.

3. The spectral radiance source of claim 2, further comprising a third integrating sphere, wherein the third integrating sphere is arranged inside the first integrating sphere and outside the second integrating sphere, and the center of the third integrating sphere coincides with the center of the first integrating sphere;
wherein a third light exit port is arranged on the third integrating sphere, and the third light exit port is not coaxial with either the first light exit port or the second light exit port; and
wherein the inner and outer walls of the third integrating sphere are coated with the diffuse reflective material layer.

4. The spectral radiance source of claim 3, wherein the light entry port and the second light exit port are coaxially arranged, and the baffle is arranged parallel to the light entry port.

5. The spectral radiance source of claim 4, wherein the central angle corresponding to the minor arc between a third center point and a fourth center point on the third integrating sphere is determined based on the diameter of the third integrating sphere, the third center point is the center point of the third light exit port, and the fourth center point is the center point of the cross-section between the hollow connecting column and the third integrating sphere.

6. The spectral radiance source of claim 3, wherein the number of the third integrating sphere(s) is one or more, and when the number of the third integrating spheres is more than one, the third light exit ports on respective third integrating spheres are not coaxial with each other.

7. The spectral radiance source of claim 1, wherein the central angle corresponding to the minor arc between a first center point and a second center point on the second integrating sphere is determined based on the diameter of the second integrating sphere, wherein the first center point is the center point of the second light exit port, and wherein the second center point is the center point of the light entry port.

8. The spectral radiance source of claim 7, wherein the baffle is arranged perpendicular to the tangent of the minor arc.

9. The spectral radiance source of claim 1, wherein the first light exit port and the hollow connecting column are coaxially arranged.

10. A spectral radiance calibration method implemented based on the spectral radiance source of claim 1, comprising:
controlling an optical instrument to be calibrated to collect the spectral radiance of the light emerging from the first light exit port of the spectral radiance source; and
obtaining the calibration result of the optical instrument to be calibrated based on the spectral radiance value collected by the optical instrument to be calibrated and the known spectral radiance value of the spectral radiance source.

11. The spectral radiance source of claim 2, wherein the first light exit port and the hollow connecting column are coaxially arranged.

12. The spectral radiance source of claim 3, wherein the first light exit port and the hollow connecting column are coaxially arranged.

13. The spectral radiance source of claim 4, wherein the first light exit port and the hollow connecting column are coaxially arranged.

14. The spectral radiance source of claim 5, wherein the first light exit port and the hollow connecting column are coaxially arranged.

15. The spectral radiance source of claim 6, wherein the first light exit port and the hollow connecting column are coaxially arranged.

16. The spectral radiance source of claim 7, wherein the first light exit port and the hollow connecting column are coaxially arranged.

17. The spectral radiance source of claim 8, wherein the first light exit port and the hollow connecting column are coaxially arranged.
